(19) United States
(12) Patent Application Publication
(10) Pub. No.: US 2022/0207603 A1
(43) Pub. Date: Jun. 30, 2022

(54) MANAGEMENT SYSTEM, MANAGEMENT METHOD, AND NON-TRANSITORY INFORMATION RECORDING MEDIUM

(71) Applicant: Rakuten Group, Inc., Tokyo (JP)

(72) Inventor: Hirofumi ARAKI, Tokyo (JP)

(73) Assignee: Rakuten Group, Inc., Tokyo (JP)

(21) Appl. No.: 17/543,921

(22) Filed: Dec. 7, 2021

(30) Foreign Application Priority Data
Dec. 28, 2020 (JP) 2020-219439

(51) Int. Cl. G06Q 40/02; G06Q 10/08; G06Q 30/08

(52) U.S. Cl. CPC G06Q 40/02; G06Q 30/08; G06Q 10/083

(57) ABSTRACT

Disclosed is a management system for management of schedules of delivery of products directed to users that allows users to exchange products before delivery of the products. A management server in the management system manages schedules of delivery of products directed to users using a database. A first receiver receives a first selection of selecting a first schedule of delivery of a first product directed to a first user defined as a first destination, from a first terminal used by the first user. A second receiver receives a second selection of selecting a second schedule of delivery of a second product directed to a second user defined as a second destination from a second terminal used by the second user. In response to reception of the first and second selections, an exchanger exchanges the first destination involved in the first schedule with the second destination involved in the second schedule.

### CROSS-REFERENCE TO RELATED APPLICATION

This application claims the benefit of Japanese Patent Application No. 2020-219439, filed on Dec. 28, 2020, the entire disclosure of which is incorporated by reference herein.

### FIELD

The present disclosure relates to a management system for management of schedules of delivery of products directed to users, a management method, and a non-transitory information recording medium.

### BACKGROUND

Techniques have been proposed to specify a product in response to a user's request for lottery and deliver the specified product. For example, Unexamined Japanese Patent Application Publication No. 2005-043982 discloses a technique that “ . . . a lottery is conducted on a network to collect consumers . . . prize money or product to be delivered . . . to consumers who are winners”.

In addition, some lottery services have been provided which allow a user to participate in a lottery by paying money, electronic money, or various points as a participation fee and specify a prize from among subject character goods and the like to be won in the lotteries. Such lottery services often involve so-called “no-lose lotteries” in which users always win some products from among the subject goods.

Some of these lottery services do not involve delivery because the prizes are electronic items (refer to Unexamined Japanese Patent Application Publication No. 2020-108596), while the others involve delivery of real products.

Some of the lottery services involving delivery of real products conduct lotteries only during a certain lottery period and are intended to maintain the rarity of products by waiting for the elapse of the lottery period, determining the number of the products to be delivered to winning users, and then starting to manufacture the products.

In another case of lotteries to win products that have already been manufactured, the order and delivery of the products take non-negligible time. That is, a certain period of time is usually required from conduction of a lottery until delivery of a product.

### SUMMARY

In the above-mentioned lottery services, a user who repetitively participates in the same lottery multiple times may win the same product twice or more. Especially when the user participates in the lottery repeatedly but fails to win the product that the user desires, the user often wins another product many times that the user does not like very much.

Required is a technique to allow users to readily exchange products, which are not only the products won in lottery services but also general products that the users do not like very much, before delivery of the products and thus facilitate communication between the users and improve their satisfactions.

An objective of the present disclosure, which has been accomplished to solve the above problems, is to provide a management system for management of schedules of delivery of products directed to users, a management method, and a non-transitory information recording medium that can allow users to exchange products before delivery of the products.

In order to solve the above problems, a management system according to an aspect of the present disclosure is for management of schedules of delivery of products directed to users. The management system receives a first selection of selecting a first schedule of delivery of a first product directed to a first user defined as a first destination from a first terminal used by the first user, receives a second selection of selecting a second schedule of delivery of a second product directed to a second user defined as a second destination from a second terminal used by the second user, and exchanges the first destination involved in the first schedule with the second destination involved in the second schedule, in response to reception of the first selection and the second selection.

The present disclosure can provide a management system for management of schedules of delivery of products directed to users, a management method, and a non-transitory information recording medium that can allow users to exchange products before delivery of the products.

### BRIEF DESCRIPTION OF THE DRAWINGS

A more complete understanding of this application can be obtained when the following detailed description is considered in conjunction with the following drawings, in which:

FIG. 1 is an explanatory diagram illustrating cooperation of devices that configure a management system;

FIG. 2 is an explanatory diagram illustrating a relationship among the individual components in a management server;

FIG. 3 is a flowchart illustrating control flows of a management process executed at the server in the management system;

FIG. 4 is a flowchart illustrating control flows of the management process executed at the server in the management system;

FIG. 5 is a flowchart illustrating a control flow of the management process executed at the server in the management system;

FIG. 6 is a session diagram illustrating steps of communication executed until exchange of products in the management system;

FIG. 7 is an explanatory diagram illustrating a lottery form;

FIG. 8 is an explanatory diagram illustrating a winning form;

FIG. 9 is an explanatory diagram illustrating a history form;

FIG. 10 is an explanatory diagram illustrating a specification form;

FIG. 11 is an explanatory diagram illustrating a pop-up form;

FIG. 12 is an explanatory diagram illustrating a candidate form;

FIG. 13 is an explanatory diagram illustrating another candidate form;

FIG. 14 is an explanatory diagram illustrating another candidate form;

FIG. 15 is an explanatory diagram illustrating another candidate form; and

FIG. 16 is an explanatory diagram illustrating another candidate form.

### DETAILED DESCRIPTION

An embodiment of the present disclosure is described below. The embodiment is provided for explanatory purposes only and is not intended to limit the scope of the present disclosure. That is, persons skilled in the art can replace some or all of the components of the embodiment with equivalent components and thereby configure other embodiments, which are also encompassed in the scope of the present disclosure.

Configuration of management system A management system according to the embodiment manages schedules of delivery of products directed to users. In this management system, one or more servers cooperate with terminals, such as smartphones, tablet computers, and personal computers, to provide users of the terminals with exchange services of the managed products.

The managed products are each a product scheduled to be delivered to a user in the future but has not yet been delivered until now.

A typical example of the managed products according to the embodiment is a pre-ordered product bought before the launch date in an electronic market.

Another example of the managed products according to the embodiment is a product specified as a result of a lottery in a lottery service in which a user participates, that is, a prize of the lottery. This prize is assumed to be delivered to the user not immediately but a certain period after determination of the result of the lottery. In some cases, manufacture of the prize is started after expiration of the period of the lottery.

Examples of the products according to the embodiment include “articles” and “objects”, some of which are presumed to be sold solely but others are not assumed to be sold solely.

The “articles” and “objects” may be products and items, such as novelty goods distributed for free for purposes of advertisement, or won in a lottery in which a user can participate on the condition of purchase of a paid product or service, for example. In some cases, as described below as an exemplary embodiment, a user can participate in a lottery by paying some fee but cannot directly buy the product or item solely which the user desires to win.

Although the server or the terminal according to the embodiment is achieved by executing of a program at a computer in general, the processes may also be executed at a dedicated electronic circuit.

Alternatively, as an intermediate configuration of the computer and the dedicated electronic circuit, the server or the terminal according to the embodiment may be configured by applying a technique of, for example, a field programmable gate array (FPGA) for dynamic configuration of an electronic circuit on the basis of a design script of the electronic circuit into which the program is compiled.

The server according to the embodiment can be achieved such that one or more server computers, which communicate with terminals to receive exchange services, execute one or more server programs to perform individual functions.

The terminal according to the embodiment can be achieved such that a terminal computer serving as a smartphone or the like downloads a terminal program distributed by a provider or manager of the exchange services via a distribution server.

The terminal program may be a program corresponding to a so-called “application (app)”.

Alternatively, the terminal program may be a general browser or a script program that can operate in the browser.

In these cases, the application or browser operating in the terminal computer communicates with the server of the management system that functions as an application server or web server, and thereby serves as an interface for providing the user with exchange services.

In general, the program to be executed at the server computer or the terminal computer can be recorded in a non-transitory computer-readable information recording medium, such as compact disk, flexible disk, hard disk, optical magnetic disk, digital video disk, magnetic tape, read only memory (ROM), electrically erasable programmable ROM (EEPROM), flash memory, or semiconductor memory. This information recording medium may be distributed or sold independently from the server computer or the terminal computer.

In the server computer or the terminal computer, the program recorded in a non-transitory information recording medium, such as flash memory or hard disk, is loaded into a random access memory (RAM), which is a temporary storage, and then the instructions contained in the loaded program is executed at a central processing unit (CPU). In contrast, in an architecture in which the ROM and the RAM can be mapped and executed in a single memory space, the instructions contained in the program stored in the ROM are directly loaded and executed at the CPU.

The server program or the terminal program may be distributed or sold, for example, from a distribution server managed by the provider to the server computer or the terminal computer via a transitory transmission medium, such as computer communication network, independently from the computer to execute the program.

In the case where the server for providing exchange services is configured by multiple computers, the programs operating in the individual computers correspond to mutually different server programs having mutually different functions and cooperating with each other. These programs in combination can thus be deemed as a system program for achieving the management system.

The following description is directed to an example in which a managed product is a prize specified by a lottery, which will be manufactured and delivered at a later date, in order to facilitate an understanding of the present disclosure.

Entire Configuration

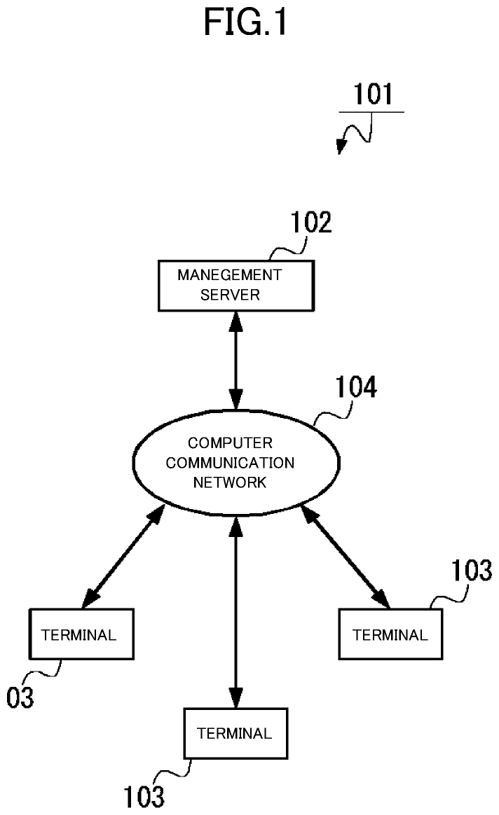

FIG. 1 is an explanatory diagram illustrating cooperation of devices that configure a management system. The following description is made with reference to this figure.

In a management system 101 illustrated in FIG. 1, a management server 102 and terminals 103 are connected so as to communicable with each other via a computer communication network 104, such as the Internet.

The management system 101 according to the embodiment also provides lottery services.

A user using each of the terminals 103 transmits a request for lottery via the terminal 103 to the management server 102. The management server 102 conducts a lottery and causes a product specified as a result of the lottery, that is, a prize, to be manufactured as required and delivered to the user at a later date.

The management server 102 then transfers information including the product (prize) specified as a result of the lottery, the user to which the prize is to be delivered, and the scheduled date and time of delivery, to the management server 102 of the management system 101.

The management server 102 manages schedules each of which involves a product serving as a prize, a user to which the prize is to be delivered, and a delivery timing when the prize is to be delivered, in association with each other. Typically, these schedules are managed in a database 168 by the management server 102.

The database 168 may be a single database for comprehensive management of all the users, may have a data structure, such as list or array, for management in the unit of a user, or may be achieved by files in various formats in the unit of a user.

Although FIG. 1 illustrates an example in which the management server 102 is a single server computer that provides exchange services by itself, multiple server computers divided depending on the functions may cooperate with each other and provide exchange services.

For example, the individual functions of the management server 102 may be assigned to a lottery computer to execute processes of lotteries and prizes, a database computer to record information, such as user information and results of the lotteries, a manufacturing management computer to manage manufacture of products depending on the results of the lotteries, and a delivery computer to manage delivery of the manufactured products.

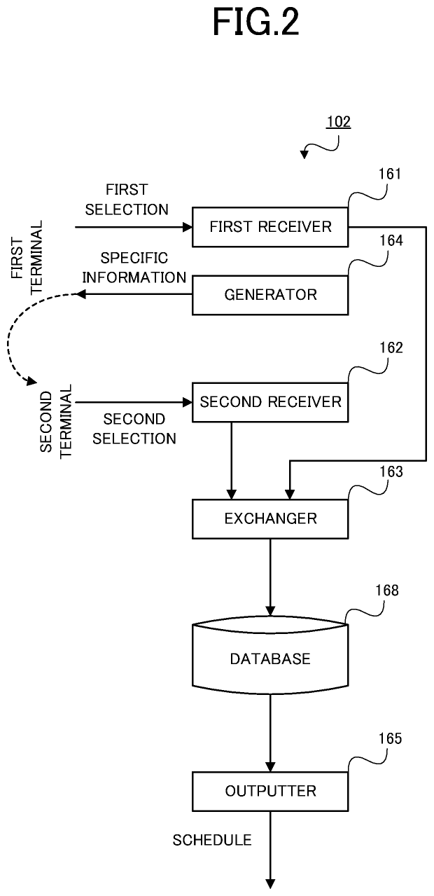

FIG. 2 is an explanatory diagram illustrating a relationship among the individual components in the management server. The following description is made with reference to this figure.

As illustrated in FIG. 2, the management server 102 according to the embodiment manages schedules of delivery of products directed to users, and includes a first receiver 161, a second receiver 162, and an exchanger 163. The management server 102 may further include a generator 164 and an outputter 165, which may be excluded.

In the most basic configuration, the first receiver 161 receives a first selection of selecting a first schedule of delivery of a first product directed to a first user defined as a first destination, from a first terminal 103 used by the first user.

In contrast, the second receiver 162 receives a second selection of selecting a second schedule of delivery of a second product directed to a second user defined as a second destination, from a second terminal 103 used by the second user.

In response to reception of the first selection and the second selection, the exchanger 163 exchanges the first destination involved in the first schedule with the second destination involved in the second schedule, in the database 168 in which the schedules are managed.

This configuration enables the users to exchange products scheduled to be delivered to the users, on the basis of the intentions of the users, before delivery of the products.

The exchange at the exchanger 163 can be achieved by overwriting the managed schedules in the database 168, or deleting and adding schedules in the database 168.

In the former case, the exchange is achieved by overwriting the destination in the record of the first schedule with the second user and overwriting the destination in the record of the second schedule with the first user in the database 168.

In the latter case, the exchange is achieved by deleting the record of the first schedule and the record of the second schedule from the database 168 and thereby excluding these schedules from the schedules managed by the management system 101, and adding a record of a third schedule of delivery of the second product directed to the first user and a record of a fourth schedule of delivery of the first product directed to the second user to the database 168 and thereby adding these schedules to the schedules managed by the management system 101.

The above-described configuration assumes that the first user and the second user negotiate with each other on products to be exchanged via a social network service (SNS), for example, and then receive an exchange service according to the embodiment.

In order to confirm that a negotiation on exchange was held, the generator 164 may generate specific information to be associated with a first selection in response to reception of the first selection at the management server 102, and the management server 102 may deem a user using a terminal 103 that accesses the management server 102 on the basis of this specific information to be the second user using the second terminal 103 and allow for reception of the second selection.

In this case, the management server 102 may deem the user that accesses the management server 102 not on the basis of the specific information to be the first user and receives the first selection.

The specific information is provided to the first user in the form of a universal resource locator (URL) to access the management server 102 or an image of the two-dimensional code corresponding to this URL.

The first user then transfers the specific information to another user, who is the negotiation partner, via SNS, for example.

That is, the management server 102 provides the first user with the generated specific information via the first terminal 103, and thereby enables the first user to inform the second user of the specific information.

When the user, who is the negotiation partner, receiving the specific information accesses the management server 102 on the basis of the specific information, this negotiation partner is deemed to be the second user, and the terminal used in the access to the management server 102 is deemed to be the second terminal 103.

The management server 102 may present information on the first product that the first user is intended to exchange, to the second user, when the second user accesses the management server 102 on the basis of the specific information. This configuration enables the second user to confirm whether the product on which negotiation was held is identical to the first product.

Furthermore, the management server 102 may ask the first user whether to accept exchange in response to reception of the second selection at the management server 102, and the exchange may require a necessary condition that the first user provides a response indicating acceptance of the exchange to the management server 102.

This configuration can present information on the second product related to the second selection to the first user and can thus allow the first user to confirm whether the product on which negotiation was held is identical to the second product.

Alternatively, the exchange at the exchanger 163 may require a necessary condition that the second selection is the earliest selection received before a first exchange deadline involved in the first schedule and before a second exchange deadline involved in the second schedule.

This condition allows only the users who conducted negotiation to exchange products, regardless of later leakage of the specific information, for example.

To each of the schedules managed by the management system 101, typically, a delivery timing indicating a timing of scheduled delivery of the product involved in the schedule, an exchange deadline indicating a deadline until when the product is exchangeable before being delivered, and an output timing indicating a timing of output of a planning sheet or the like to start manufacture or delivery of the product can be assigned. In general, the output timing coincides with the exchange deadline or precedes the exchange deadline, and the exchange deadline coincides with the delivery timing or precedes the delivery timing. Alternatively, any one or two of these three timings and deadline may be stored in each schedule, and the remaining one or two of the timings and deadline may be calculated by adding or subtracting a predetermined grace period to or from the stored one or two of the timings and deadline.

The exchange deadline involved in the schedule is referred to as described above in order to determine the condition related to the exchange deadline.

Alternatively, the first user may designate a first product that the first user is intended to exchange, make a first selection without negotiation with another user, and provide specific information provided from the management server 102 to many unspecified users, via SNS, for example. In this configuration, other users individually make second selections as second users. The first user receives one or more inquiries in the case where multiple other users want the first product.

The first user carefully checks the second products related to the second selections in the received inquiries, and provides a response that “exchange is acceptable” to an inquiry when finding a product that the first user likes to exchange.

The specific information is then disassociated from the first selection, and a response that “exchange is unacceptable” is provided to the other second selections. The first user may provide an explicit response that “exchange is unacceptable” to the other inquiries and thereby notify the second users of no intention of exchange. Alternatively, the management server 102 may automatically notify the second users of no intension of exchange.

In the case where another terminal 103 accesses the management server 102 on the basis of the specific information disassociated from the first selection, the user of the terminal 103 receives a report indicating refusal of the exchange with the first product involved in the first schedule.

This configuration can be applied to barter trades in auctions.

The outputter 165 is used in a configuration in which the managed products are prizes of lotteries conducted before manufacture of the products and started to be manufactured depending on the type and number of prizes after elapse of a predetermined lottery period. The outputter 165 outputs a schedule that reaches the output timing involved in the schedule among the schedules managed by the management system 101.

Although the first user selects a first schedule and the second user selects a second schedule in the above description, each of the users may view a list of products scheduled to be delivered to the user when accessing the management server 102 via the terminal 103, and the user's selection of any product from the list may be deemed to be a selection of the schedule involving this product.

That is, the selected first schedule may be the schedule involving a product designated by the first user via the first terminal 103 from among products to be delivered to the first user, and the selected second schedule may be the schedule involving a product designated by the second user via the second terminal 103 from among products to be delivered to the second user.

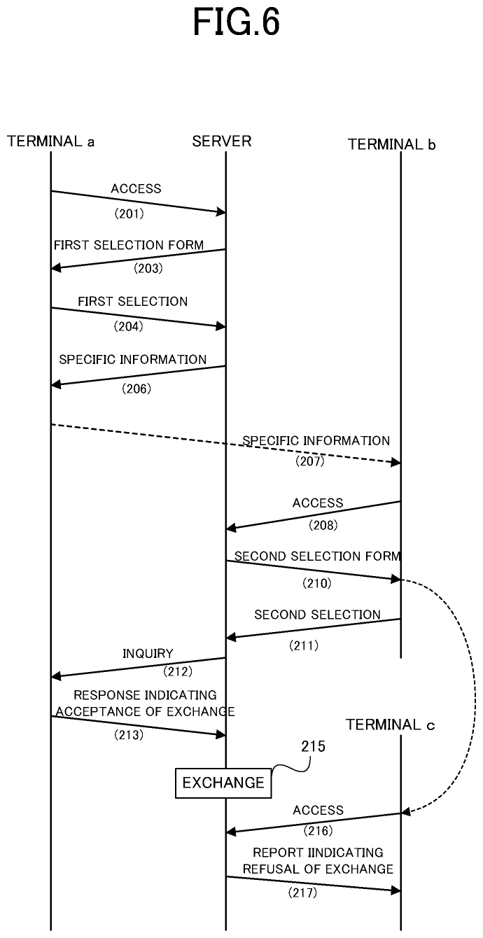

FIG. 6 is a session diagram illustrating steps of communication executed until exchange of products in the management system. This figure illustrates an example in which the management server (server) 102 and three terminals including a terminal 103a (terminal a), a terminal 103b (terminal b), and a terminal 103c (terminal c) respectively used by users a, b, and c communicate with each other and try to exchange products scheduled to be delivered to the users themselves.

The management server 102 is assumed to have already managed the schedules of delivery of products directed to the individual users a, b, and c in the database 168. In the case of the management server 102 also providing lottery services, the terminals 103a, 103b, and 103c used by the users a, b, and c and the management server 102 also conduct communication (not illustrated) related to the lottery services.

First, the terminal 103a of the user a accesses the management server 102 (not on the basis of the specific information) (201).

In response to this requirement, the management server 102 generates a first selection form indicating a list of products that are scheduled to be delivered to the user a and are still exchangeable, and transmits the generated form to the terminal 103a (203).

When the user a selects any of the products presented in the first selection form via the terminal 103a, the schedule involving this product is deemed to be a first selection and is transmitted from the terminal 103a of the user a to the management server 102 (204).

The management server 102 that receives the first selection generates specific information to be associated with this first selection and transmits the generated specific information to the terminal 103a (206).

The user a of the terminal 103a transfers the received specific information to the terminal 103b used by the user b, via email or SNS, for example (207).

The user b accesses the management server 102 via the terminal 103b on the basis of the specific information transferred from the user a (208).

In FIG. 6, the specific information is transferred directly from the terminal 103a to the terminal 103b. This configuration corresponds to an example in which the user a sends a message containing the URL indicating the specific information from the terminal 103a to the terminal 103b of the user b, and the user b clicks this URL at the terminal 103b.

Alternatively, the user a may send a two-dimensional code indicating the specific information to the user b, and the user b may cause the two-dimensional code to be displayed on the screen of a device other than the terminal 103b, read the code using a smartphone or the like corresponding to the terminal 103b, and thus make an access based on the specific information, for example.

In response to the access from the terminal 103b based on the specific information, the management server 102 generates a second selection form indicating a list of products that are scheduled to be delivered to the user b and are still exchangeable, and transmits the generated form to the terminal 103b (210).

When the user b selects any of the products presented in the second selection form via the terminal 103b, the schedule involving this product is deemed to be a second selection and is transmitted from the terminal 103b of the user b to the management server 102 (211).

When receiving the second selection made on the basis of the specific information associated with the first selection, the management server 102 asks the terminal 103a whether to accept exchange between the first destination involved in the first schedule selected in the first selection and the second destination involved in the second schedule selected in the second selection (212).

When receiving a response indicating acceptance of the exchange from the terminal 103a (213), the management server 102 disassociates the specific information from the first selection, and exchanges the first destination involved in the first schedule selected in the first selection and the second destination involved in the second schedule selected in the second selection (215).

When the user c who obtains the specific information later by any procedure accesses the management server 102 via the terminal 103c on the basis of the specific information (216), the management server 102 generates a report indicating refusal of the exchange and transmits the generated report to the terminal 103c (217).

This report is displayed on the screen of the terminal 103c and thereby informs the user c that the specific information has already been invalidated and exchange of the products is not available.

The steps of the inquiry about the exchange (212) and the response (213) may be omitted. In this case, the first schedule selected in the first selection is exchanged with the second schedule selected in the second selection that is received earliest among the second selections related to certain specific information.

In the figures of the present application referenced in the following description, “AAA” represents the identification name of the user a and “BBB” represents the identification name of the user b as appropriate, in order to facilitate an understanding.

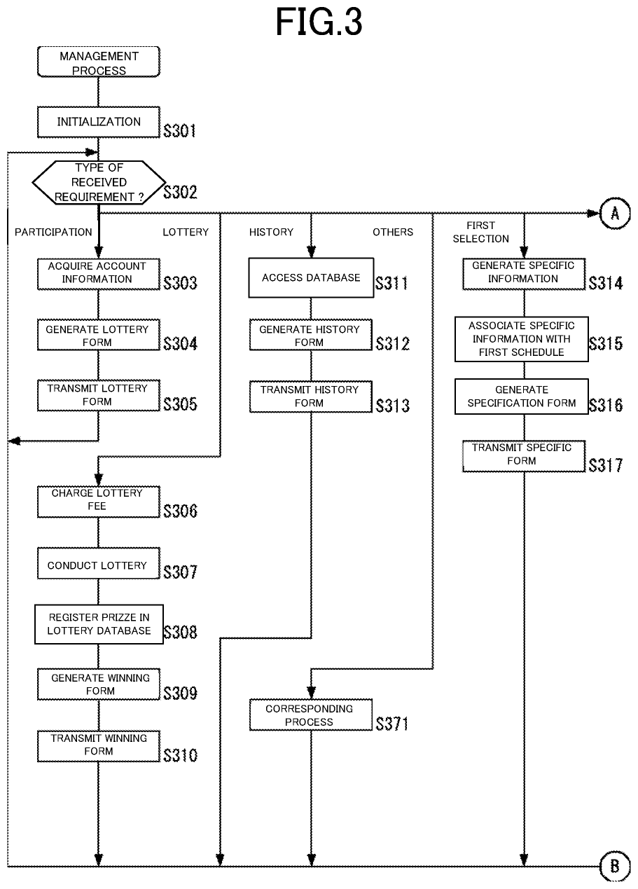

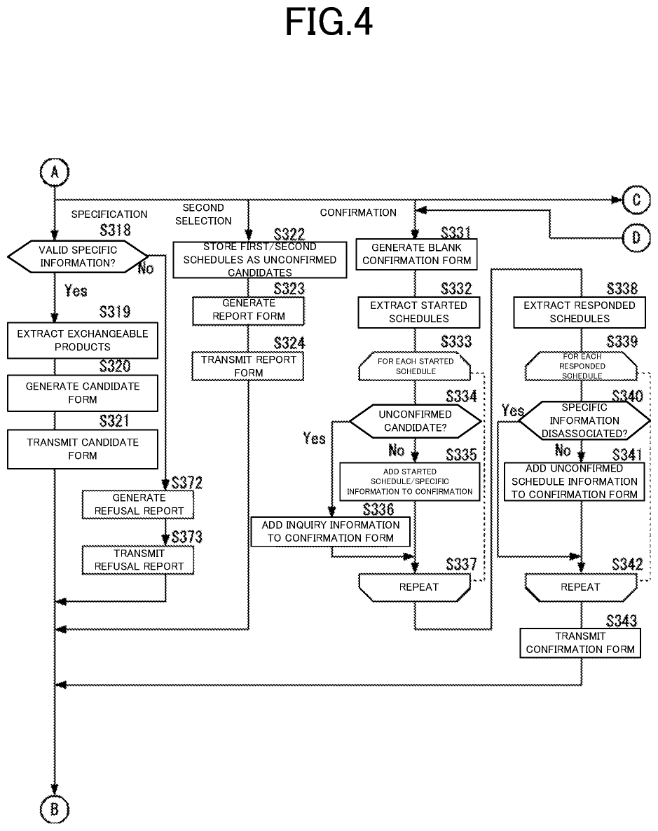

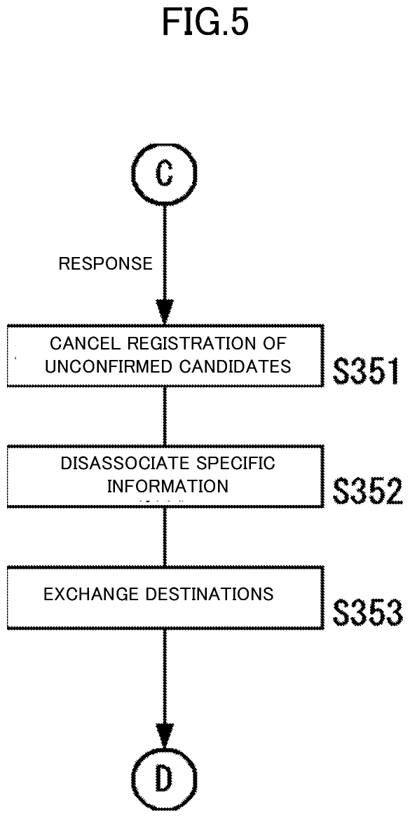

FIGS. 3, 4, and 5 are each a flowchart illustrating control flows of a management process executed at the server in the management system. The following description is made with reference to these figures.

After the start of this process, the management server 102 executes various initializations (Step S301), and waits for reception of a requirement from any terminal 103 (Step S302).

When any user accesses the management server 102 via the terminal 103 to participate in a lottery service, the management server 102 receives a participation requirement from the terminal 103 (Step S302; participation). The management server 102 then acquires account information on the user using this terminal 103 (Step S303). Examples of the account information include the number of points currently owned by the user and payment information, such as information on a credit card for use in payment of the lottery fee.

The management server 102 then generates a lottery form on the basis of the account information (Step S304), and transmits the generated lottery form to the terminal 103 (Step S305). The management server 102 then returns to Step S302.

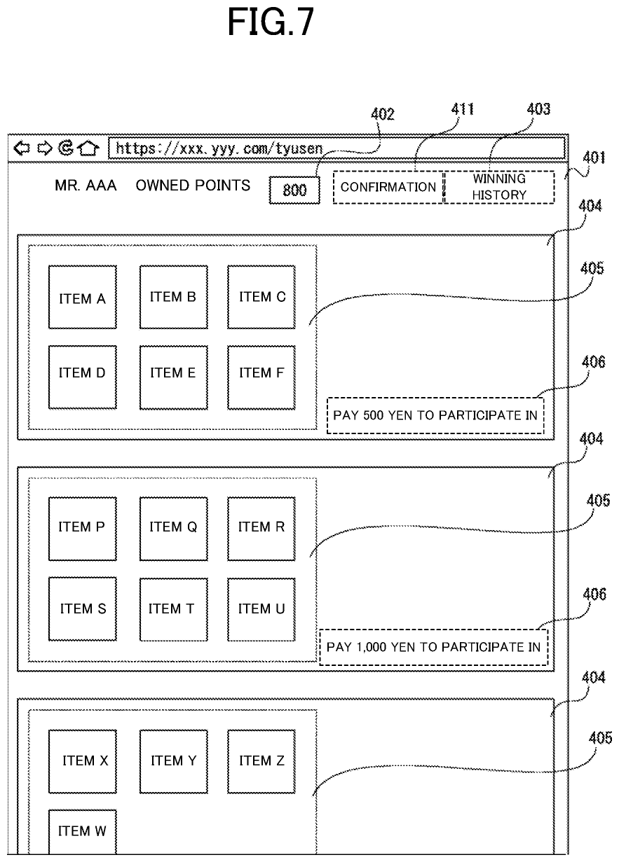

The terminal 103 causes the received lottery form to be displayed on the screen. FIG. 7 is an explanatory diagram illustrating the lottery form. The following description is made with reference to this figure. Objects arranged in each form and can be selected by the user are called “links” in the description below. These “links” can be achieved by not only anchoring elements in hypertext markup language (HTML) but also other graphical user interface (GUI) elements, such as button objects, for example.

As illustrated in FIG. 7, the lottery form 401 contains a point field 402 representing the number of points currently owned by the user, a history link 403 to view a list of prizes that the user won in the past, and lottery information items 404 representing lotteries in which the user can currently participate. Each of the lottery information items 404 contains a subject product field 405 representing products to be won in the lottery, and a participation link 406 explicitly indicating a lottery fee to be paid for participation in the lottery.

The lottery form 401 also contains a confirmation link 411 to confirm products and the like on which the user is currently intended to receive exchange services.

In FIG. 7, the lottery form 401 is displayed in a scrollable manner. The lottery information item 404 in the top row contains the subject product field 405 representing items A to F and the participation link 406 indicating a participation fee of 500 yen. The lottery information item 404 in the middle row contains the subject product field 405 representing items P to U and the participation link 406 indicating a participation fee of 1,000 yen. The lottery information item 404 in the bottom row is only partially displayed, and contains the subject product field 405 representing items X to W.

The user clicks the participation link 406 at the terminal 103 and thereby makes a request for lottery, so that a lottery requirement is transmitted from the terminal 103 to the management server 102.

When receiving the lottery requirement (Step S302; lottery), the management server 102 executes a process of charging the user for the lottery fee (Step S306). The charging process may use the credit card or debit card contained in the account information, or may cause the user to select a charging option via the terminal 103.

In the example illustrated in FIG. 7 in which the point field 402 represents the current points of “800”, the lottery fee is paid as described below. For example, when the user clicks the participation link 406 in the top row, 500 points are consumed from the current points, leaving the points of “300”. When the user clicks the participation link 406 in the middle row, all the points are consumed and additional 200 yen is charged to the credit card or the like.

The management server 102 then conducts a lottery by specifying any one of the products to be won in the lottery, depending on the probabilities assigned to the individual products (Step S307).

The management server 102 then causes a schedule, in which the account information on the user and the prize specified as a result of the lottery are associated with each other as a destination and a product to be delivered to the destination, to be registered in the database 168 as a schedule to be managed (Step S308). To this schedule, an exchange deadline, an output timing, and a delivery timing may be assigned as appropriate, for example.

The management server 102 then generates a winning form representing the prize (Step S309), and transmits the generated form to the terminal 103 (Step S310). The management server 102 then returns to Step S302.

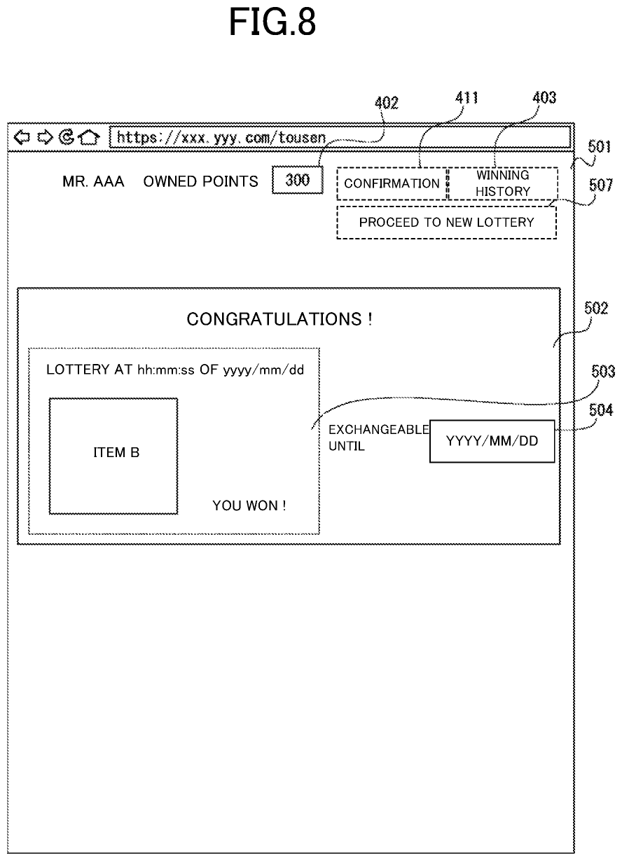

The terminal 103 causes the received winning form to be displayed on the screen. FIG. 8 is an explanatory diagram illustrating the winning form. The following description is made with reference to this figure.

As illustrated in FIG. 8, a winning form 501 contains the point field 402 and the history link 403 like the lottery form 401, and also contains a winning information item 502. The winning form 501 further contains a continuation link 507 to proceed to another lottery. When the user clicks the continuation link 507, the terminal 103 transmits a participation requirement to the management server 102 and can thus make another request for lottery.

The winning information item 502 contains a prize field 503 representing details of the prize and a deadline filed 504 representing the deadline for exchange of this prize.

In FIG. 8, the prize field 503 of the winning information item 502 represents that the user wins the item B as a result of clicking the participation link 406 of the lottery information item 404 in the top row in the lottery form 401 in FIG. 7.

The point field 402 represents the remaining points of 300 because 500 yen (500 points) was paid for participation in the lottery.

A flow of control is described below with reference to the exemplary steps illustrated in FIG. 6. When the user a clicks the history link 403 disposed in any form at the terminal 103a, a history requirement is transmitted from the terminal 103 to the management server 102. This history requirement corresponds to the access not on the basis of the specific information (201).

When receiving the history requirement (Step S302; history), the management server 102 accesses the database 168, acquires information on prizes (Step S311), generates a history form (Step S312), and transmits the generated form to the terminal 103a (Step S313). The management server 102 then returns to Step S302. The history form transmitted in this step corresponds to the first selection form (203).

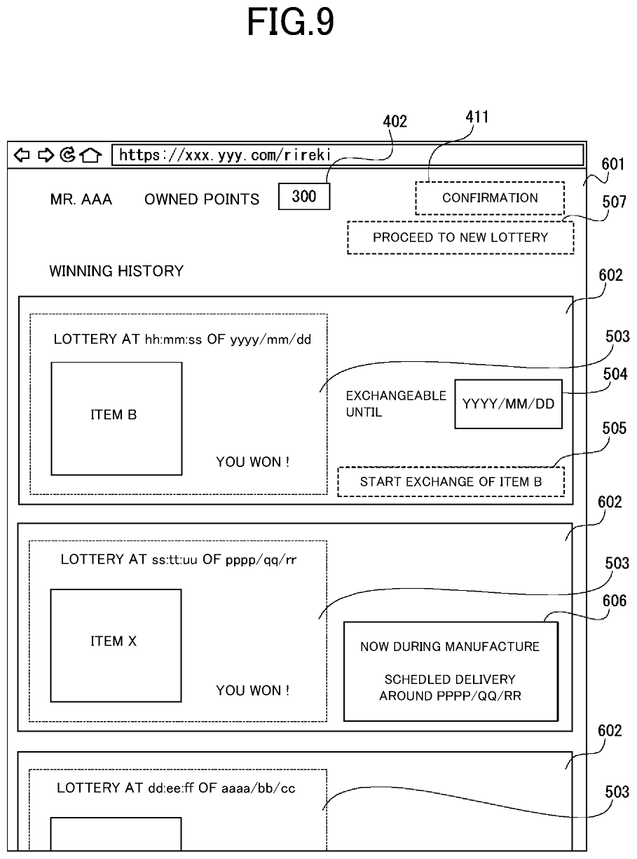

The terminal 103a used by the user a causes the received history form to be displayed on the screen. FIG. 9 is an explanatory diagram illustrating the history form. The following description is made with reference to this figure.

A history form 601 contains the point field 402 and the continuation link 507 like the winning form 501, and contains an array of history information items 602 related to the respective prizes that the user won in the past. In FIG. 9, the history information items 602 are displayed in a scrollable manner.

Each of the history information items 602 contains the prize field 503 representing the details of the prize. When this prize is still exchangeable (that is, when the current time is before the predetermined exchange deadline), the history information item 602 also contains the deadline filed 504 and an exchange start link 505, like the history information item 602 in the top row illustrated in FIG. 9.

When the user a clicks the exchange start link 505, a first selection requirement representing an intension to exchange the prize presented in the prize field 503 corresponding to this exchange start link 505 is transmitted from the terminal 103a to the management server 102 (204).

In contrast, when this prize is not exchangeable (that is, when the current time is after the predetermined exchange deadline), the history information item 602 contains not the deadline filed 504 and the exchange start link 505 but a current status field 606 representing the current status of the prize, such as “during manufacture” or “delivery completed”, like the history information item 602 in the middle row illustrated in FIG. 9. That is, a manipulation to exchange the prize is originally made unavailable.

When receiving the first selection requirement from the terminal 103a (Step S302; first selection), the management server 102 generates specific information (Step S314).

The management server 102 then causes a first schedule related to this first selection requirement and the generated specific information to be recorded in association with each other in an exchange database, for example (Step S315), generates a specification form representing the specific information (Step S316), and transmits the generated specification form containing the specific information to the terminal 103a (Step S317). This step corresponds to the transmission of the specific information (206) illustrated in FIG. 6.

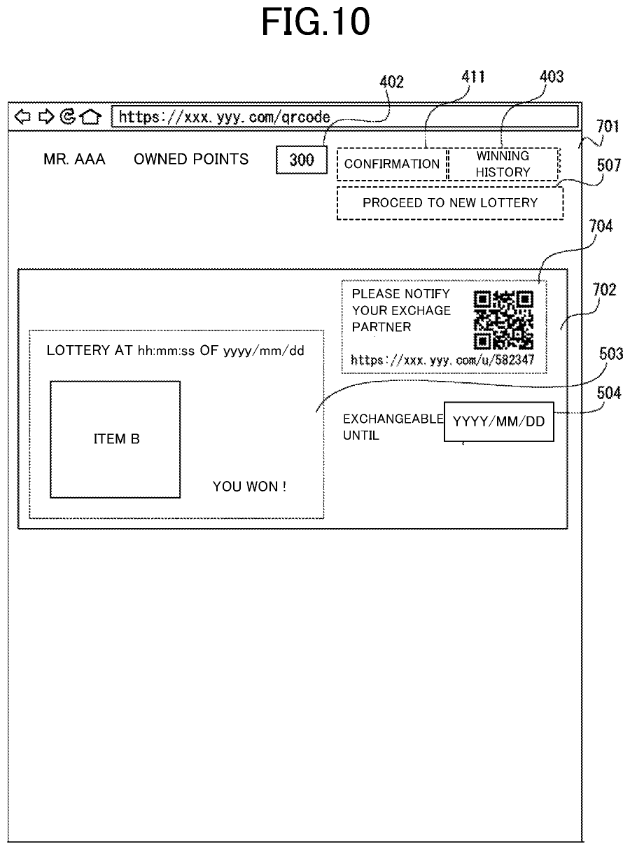

The terminal 103a causes the received specification form to be displayed on the screen. FIG. 10 is an explanatory diagram illustrating the specification form. The following description is made with reference to this figure.

A specification form 701 contains an exchange information item 702. The exchange information item 702 contains the prize field 503 representing details of the first product, which is the prize that the user a starts to exchange, and the deadline filed 504 indicating the deadline for exchange of this prize, like the winning form 501, and also contains a specific information field 704 representing the specific information to be transferred to a partner of exchange of this prize.

The specific information field 704 contains the URL and the two-dimensional code assumed to be opened by the partner (second user) of exchange of the product.

When the user a (first user) clicks the specific information field 704, a pop-up form may be displayed for sharing the URL and the two-dimensional code via email or SNS, for example, without opening of the URL or the two-dimensional code.

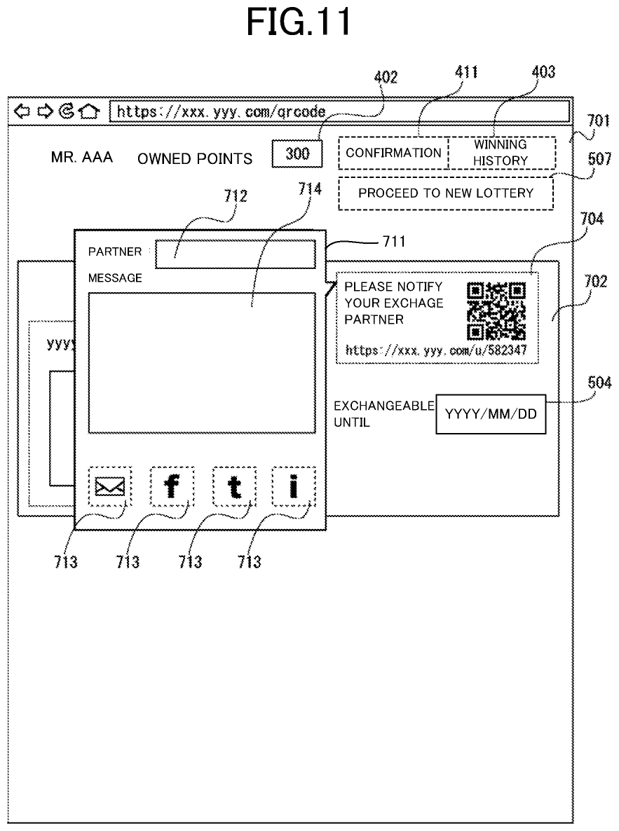

FIG. 11 is an explanatory diagram illustrating the pop-up form. In a pop-up form 711 illustrated in this figure, the user a inputs information, such as email address or ID, on the exchange partner (user b) in a partner field 712 and inputs a necessary message in a message field 714, and then clicks any of sharing links 713 corresponding to the types of email and SNS, to thereby transfer the URL and the two-dimensional code to the exchange partner (207).

When the user a clicks the sharing link 713 after inputting the information, such as email address or ID, on the exchange partner in the partner field 712, the URL and the two-dimensional code are transferred to only this partner. In an exemplary case of an SNS, the URL and the two-dimensional code are transferred to the partner in the form of a direct message.

In contrast, in order to make the URL and the two-dimensional code public via an SNS on which a message can be posted to unspecified users, the user a clicks the sharing link 713 related to the SNS while leaving the partner field 712 blank.

Alternatively, the URL and the two-dimensional code may be copied to a clipboard by selecting a copy option in an edit menu or a right-click context menu, for example.

When the user b, who obtains the URL or the two-dimensional code indicating the specific information via email or SNS, opens the URL in a browser or reads the two-dimensional code in an application at the terminal 103b, the terminal 103b makes an access based on the specific information and thus transmits, to the management server 102, a specification requirement accompanied by the specific information or information from which the specific information can be recovered. This step corresponds to the access based on the specific information (208).

When receiving the specification requirement (Step S302; specification), the management server 102 examines whether the specific information accompanying the specification requirement is associated with the first selection involved in the first schedule, that is, whether the specific information is valid (Step S318).

When the specific information is associated with the first selection involved in the first schedule and thus is valid (Step S318; Yes), the management server 102 extracts products that are involved in schedules directed to the user b using the terminal 103b that transmits the specification requirement and have not reached the exchange deadlines yet (Step S319).

The management server 102 then generates a candidate form representing the extracted products (Step S320), transmits the generated candidate form to the terminal 103b (Step S321), and returns to Step S302. The candidate form transmitted in this step corresponds to the second selection form (210).

The second selection form preferably contains information on the user a, who is the first destination involved in the first schedule acquired in Step S317, and information on the first product that the user a is intended to exchange.

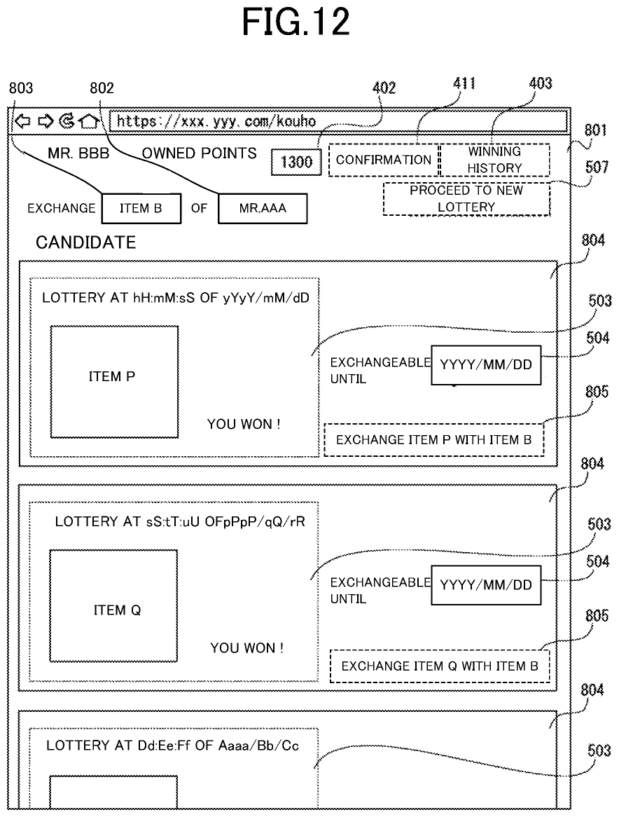

The terminal 103b causes the received candidate form to be displayed on the screen. FIG. 12 is an explanatory diagram illustrating the candidate form. The following description is made with reference to this figure.

A candidate form 801 contains a partner field 802 representing the user a, who is the exchange partner, and a product field 803 representing the first product that the user a is intended to exchange. The candidate form 801 also contains candidate information items 804 related to candidate products that the user b using the terminal 103b can exchange.

The candidate form 801 is expired at a timing that coincides with the earliest one of the exchange deadlines of the candidate products that the user b can exchange. The terminal 103b is thus set to transmit the specification requirement again using a timer in response to expiration of the candidate form 801, so as to prevent a selection from being made after the exchange deadline.

Each of the candidate information items 804 contains the prize field 503 representing the details of the prize, which is the candidate product, and the deadline filed 504, and also contains an exchange response link 805 to exchange the prize with the product owned by the user a.

When the user b clicks the exchange response link 805, a second selection requirement, in which the product related to a candidate information item 804 containing this exchange response link 805 is selected as the second product to be exchanged with the first product involved in the first schedule acquired on the basis of the specific information, is transmitted from the terminal 103b to the management server 102 (211).

When receiving the second selection requirement (Step S302; second selection), the management server 102 causes the first schedule associated with the specific information, which leads to the second selection requirement, and the second schedule related to the second selection requirement to be registered in association with each other as unconfirmed candidates (Step S322).

The management server 102 generates a report form to inform the user of the terminal 103b that transmits the second selection requirement that an inquiry on the exchange is made to the first user (Step S323), transmits the generated form to this terminal 103b (Step S324), and returns to Step S302. The terminal 103b receives the report form and causes the received form to be displayed on the screen.

The registration of the schedules as unconfirmed candidates may require a condition that the second selection requirement is received in advance of both of the first exchange deadline involved in the first schedule and the second exchange deadline involved in the second schedule.

In order to confirm the current exchange status, the user a who starts exchange of products or the user b who responds to the exchange clicks the confirmation link 411 disposed in each form at the terminal 103a or 103b. A confirmation requirement is then transmitted from the terminal 103a or 103b to the management server 102.

When receiving the confirmation requirement (Step S302; confirmation), the management server 102 first generates a confirmation form containing blank information on exchange (Step S331). The following description assumes that the confirmation form represents information on a product for which an exchange process has been started but not been completed yet, in order to facilitate an understanding.

The management server 102 extracts schedules (hereinafter referred to as “started schedules”) registered as the first schedules associated with specific information from among schedules belonging to the user using the terminal 103 that transmits the confirmation requirement (Step S332).

The management server 102 then repeats the following steps for each of the extracted started schedules (Step S333).

Specifically, the management server 102 determines whether the started schedule is registered as the first schedule in the unconfirmed candidates (Step S334).

When the started schedule is not registered (Step S334; No), this started schedule and the specific information associated with the started schedule are added to the confirmation form (Step S335). The added information has the format identical to that of the prize field 503 and the specific information field 704 illustrated in FIG. 10.

In contrast, when the started information is registered (Step S334; Yes), inquiry information on the started schedule is added to the confirmation form (Step S336). The details of the inquiry information are described below.

After repetition of the steps for the started schedules (Step S337), the management server 102 extracts schedules (hereinafter referred to as “responded schedules”) registered as the second schedule in the unconfirmed candidates from among schedules belonging to the user using the terminal 103 that transmits the confirmation requirement (Step S338).

The management server 102 then repeats the following steps for each of the extracted responded schedules (Step S339). That is, the management server 102 examines whether the specification information is disassociated from the schedule, which is the first schedule registered in association with the responded schedule (Step S340).

When the specification information is not disassociated (Step S340; No), unconfirmed schedule information indicating that the responded schedule is waiting for confirmation of the first user is added to the confirmation form (Step S341). The details of the unconfirmed schedule information are described below.

In contrast, when the specification information is disassociated (Step S340; Yes), which implies completion of the exchange related to the responded schedule, the management server 102 proceeds to Step S342 and continues repetition of the steps.

After repetition of the steps for the responded schedules (Step S342), the management server 102 transmits the confirmation form to the terminal 103 that transmits the confirmation requirement (Step S343), and returns to Step S302.

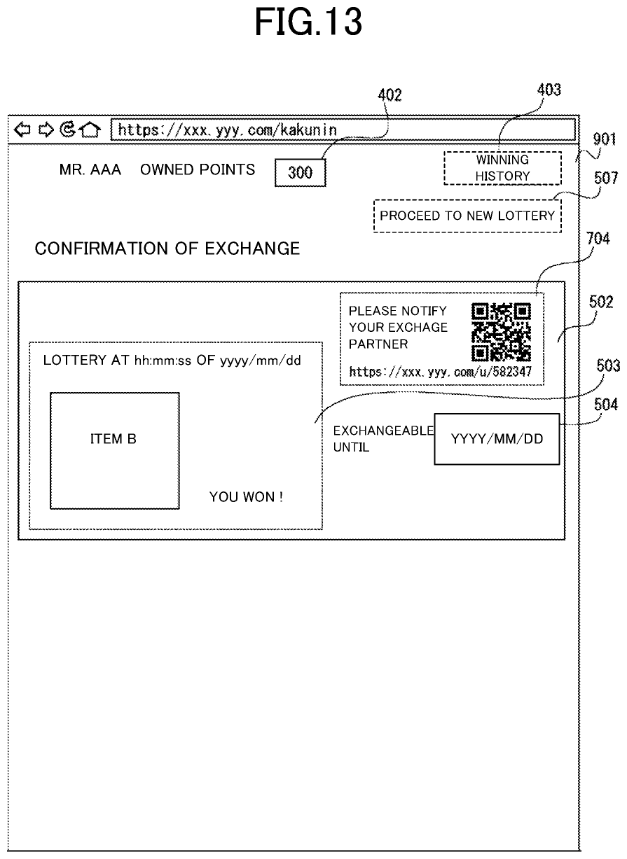

The following description assumes a case where a confirmation requirement is transmitted from the terminal 103a used by the user a to the management server 102 at a stage from the transfer of the specific information (207) to the access based on the specific information (208) illustrated in FIG. 6. In this case, although the specific information is associated with the first schedule selected in the first selection, no first schedule is registered as an unconfirmed candidate. The terminal 103a thus displays a confirmation form 901 as illustrated in FIG. 13, in which the winning information item 502 contains the prize field 503 representing the first product involved in the first schedule and the corresponding specific information field 704.

In this embodiment, the confirmation form 901 contains the point field 402, the history link 403, and the like, like the other forms.

The description then assumes another case where a confirmation requirement is transmitted from the terminal 103a used by the user a to the management server 102 immediately after the transmission of the second selection (211) illustrated in FIG. 6. In this case, the specific information is associated with the first schedule selected in the first selection and the first schedule is registered as an unconfirmed candidate. Accordingly, the confirmation form 901 transmitted from the management server 102 to the terminal 103a corresponds to the inquiry of whether to accept exchange (212).

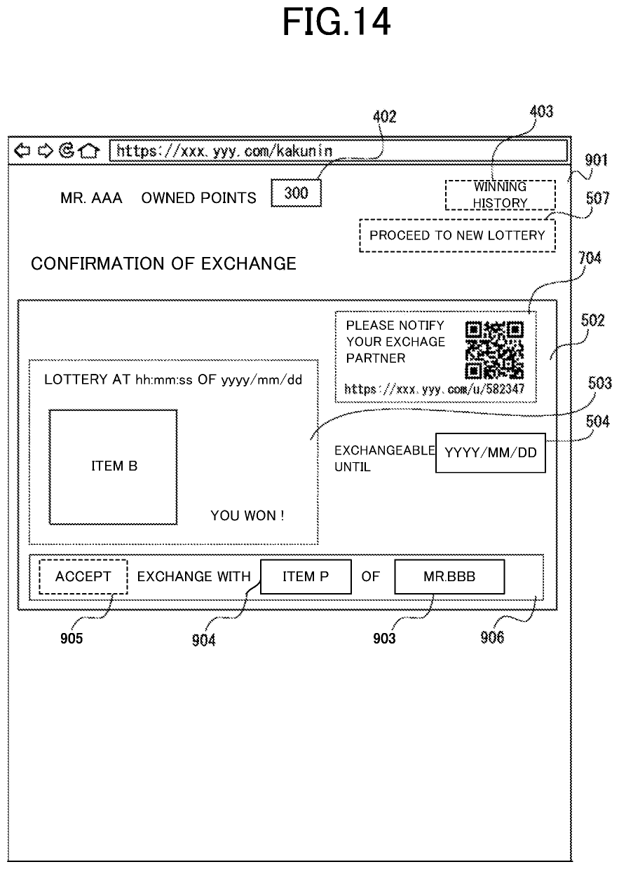

As illustrated in FIG. 14, the winning information item 502 of the confirmation form 901 displayed at the terminal 103a contains the prize field 503 representing the first product involved in the first schedule, the corresponding specific information field 704, information on the user b, who is the second destination involved in the second schedule, disposed in an exchange partner field 903, and information on the prize, which is the second product, disposed in an exchangeable product field 904. The winning information item 502 also contains a response link 905 to accept exchange related to the second schedule.

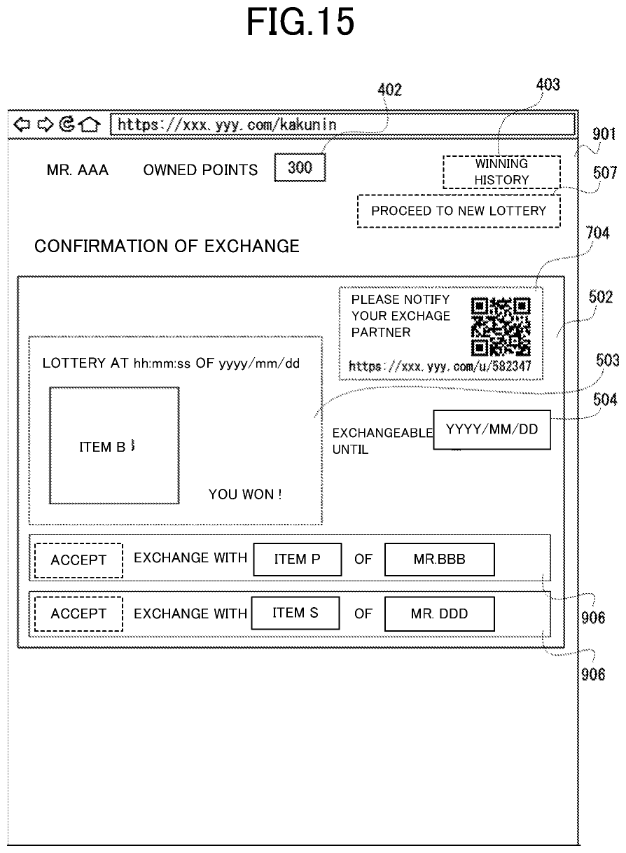

In an exemplary case, such as an auction, where multiple second users respond to the exchange related to the first schedule, the winning information item 502 contains multiple information sets 906 representing information related to the respective exchange options, as illustrated in FIG. 15.

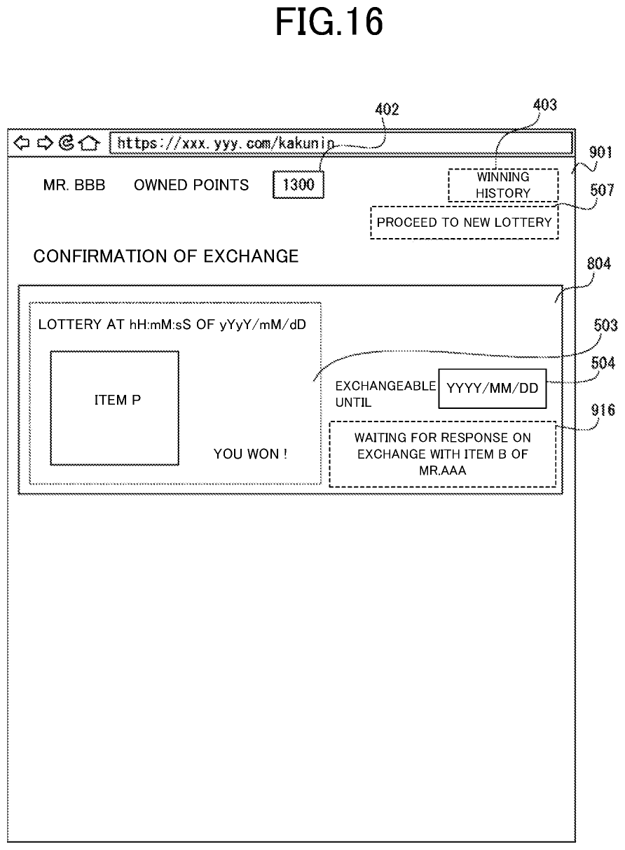

The description then assumes another case where a confirmation requirement is transmitted from the terminal 103b used by the user b to the management server 102 immediately after the transmission of the second selection (211) illustrated in FIG. 6. In this case, the second schedule is registered as an unconfirmed candidate. Accordingly, the candidate information item 804 of the confirmation form 901 transmitted from the management server 102 to the terminal 103b contains a message 916 including information on the user a, who is the first destination involved in the first schedule, and information on the prize, which is the first product, as illustrated in FIG. 16.

When the user a clicks the response link 905, a response indicating acceptance of exchange between the first destination involved in the first schedule and the second destination involved in the second schedule is transmitted from the terminal 103a to the management server 102 (213).

When receiving the response from the terminal 103a (Step S302; response), the management server 102 completely cancels the registration of the unconfirmed candidates including the first schedule related to this response (Step S351), completely disassociates the specific information from the first schedule related to the response (Step S352), and exchanges the first destination involved in the first schedule related to the response with the second destination involved in the second schedule (Step S353). This step corresponds to the disassociation and the exchange of destinations (215) illustrated in FIG. 6.

The management server 102 then returns to Step S331. That is, the process goes as in the case of transmission of the confirmation requirement by the user a or b via the terminal 103a or 103b immediately after the exchange. Since the specific information is disassociated from the first schedule and the registration of the first and second schedules as unconfirmed candidates are canceled, the confirmation form 901 does not contain these pieces of information.

The confirmation form 901 may contain a history of exchanges listed below: a first or second schedule that is registered as an unconfirmed candidate and proceeds to exchange because of a response indicating acceptance of exchange; a second schedule that is registered as an unconfirmed candidate but does not proceed to exchange because a response indicating acceptance of exchange is provided to not this schedule but another unconfirmed candidate; and a second schedule registered as an unconfirmed candidate but does not proceed to exchange because the exchange deadline has expired until reception of a response indicating acceptance of exchange, for example.

When the management server 102 receives a specification requirement (Step S302; specification) but the specific information accompanying this specification requirement is not associated with the first selection involved in the first schedule (Step S318; No), for example, when the user c illustrated in FIG. 6 makes an access via the terminal 103c (216), then the management server 102 generates a report form indicating invalidity of the specific information and refusal of exchange (Step S372), transmits the generated report form to the terminal 103c that transmits the specification requirement (Step S373), and returns to Step S302.

When the management server 102 receives another requirement (Step S302; others), executes the corresponding process (Step S371), and returns to Step S302.

The above description focuses on the communication between the terminals 103 and the management server 102 in order to facilitate an understanding, and does not mention the output at the outputter 165, or the disassociation of specific information and the canceling of the registration of unconfirmed candidates due to expiration of the exchange deadline. The output, disassociation, and canceling can be involved in a process, such as batch process, executed at regular intervals, for example.

Although the above description assumes that the terminals 103 use a browser to communicate with the management server 102, the terminals 103 may also communicate with the management server 102 via an application operating in the terminals 103. In this configuration, a push notification or the like may be transmitted from the management server 102 to the application, and thereby notify the user of a change in the status and cause the user to activate the application and conduct a process based on the change.

The application or web service for providing lotteries may also include a networking service like an SNS to facilitate communication between users.

The first user may designate a product that the first user desires to exchange with the first product in the first selection. In this configuration, a user scheduled to receive the designated product may be deemed to be the second user, and may immediately start exchange by selecting the designated product without asking the first user.

Although the specific information is the URL and the two-dimensional code in the above description, this configuration is a mere example. The specific information may also be a random number string or character string. In this case, a terminal may transmit a specification requirement when the user inputs the specific information in a form transmitted from the management server 102.

Although the first and second products are each assumed to be a single product in the above description, exchange between a single product and multiple products, and exchange between multiple products and multiple products may also be available.

For example, when a user checks the checkboxes for multiple products and then clicks an all-exchange button in a form to select products to be exchanged, the checked products may be dealt with as a single “product” and exchanged, for example.

The above-described configurations and functions may be partially excluded as appropriate, and the configuration after exclusion may also be encompassed in the technical scope of the present disclosure.

This embodiment allows the users to exchange products before receiving the products. The embodiment can therefore solve the problem in the existing techniques for exchanging products that the users have to wait until receiving products to be exchanged, have to pay transportation costs and take traveling times for the in-person exchange, and have to pay shipping costs for exchange by delivery.

The embodiment can also solve the problem in the existing techniques that the users have to provide the own personal information, such as names and addresses, to each other for delivery of real products. The embodiment can therefore respect the privacy of users and increase the level of security.

### CONCLUSION

As described above, a management system, according to a first aspect of the present disclosure, for management of schedules of delivery of products directed to users, includes: at least one memory configured to store computer program code; and at least one processor configured to access the computer program code and operate in accordance of the computer program code, the computer program code including: first receiving code configured to cause at least one of the at least one processor to receive a first selection of selecting a first schedule of delivery of a first product directed to a first user defined as a first destination, from a first terminal used by the first user; second receiving code configured to cause at least one of the at least one processor to receive a second selection of selecting a second schedule of delivery of a second product directed to a second user defined as a second destination, from a second terminal used by the second user; and exchanging code configured to cause at least one of the at least one processor to exchange the first destination involved in the first schedule with the second destination involved in the second schedule, in response to reception of the first selection and the second selection.

The management system according to the first aspect may further include generating code configured to cause at least one of the at least one processor to generate specific information to be associated with the first selection in response to reception of the first selection, wherein the management system deems a user using a terminal accessing the management system on basis of the specific information to be the second user using the second terminal and allows for reception of the second selection.

The management system according to the first aspect may provide the first user with the generated specific information via the first terminal and thereby allow the first user to inform the second user of the generated specific information.

In the management system according to the first aspect, the exchanging code may be configured to cause at least one of the at least one processor to requires a necessary condition that the second selection is an earliest selection received before a first exchange deadline involved in the first schedule and before a second exchange deadline involved in the second schedule.

The management system according to the first aspect may disassociate the specific information from the first selection after completion of exchange.

The management system according to the first aspect may provide a report, which indicates refusal of exchange with the first product involved in the first schedule, to a user using a terminal accessing the management system on the basis of the disassociated specific information.

The management system according to the first aspect may ask the first user whether to accept exchange in response to reception of the second selection, and the exchange may require a necessary condition that the first user provides a response indicating acceptance of the exchange to the management system.

In the management system according to the first aspect, each of the schedules managed by the management system may involve an output timing that precedes a delivery timing of delivery of the product involved in the schedule or coincides with the delivery timing, and the management system may further include an outputting code configured to cause at least one of the at least one processor to output a schedule that reaches the output timing involved in the schedule among the schedules managed by the management system.

In the management system according to the first aspect, a product involved in the schedule may be a product specified in response to a request for lottery from a user.

In the management system according to the first aspect, the exchanging code may be configured to cause at least one of the at least one processor to exchange the destinations, by deleting the first schedule and the second schedule from the schedules to be managed, and adding a third schedule of delivery of the second product directed to the first user and a fourth schedule of delivery of the first product directed to the second user, to the schedules to be managed.

In the management system according to the first aspect, the selected first schedule may be a schedule involving a product designated by the first user from among products to be delivered to the first user, via the first terminal, and the selected second schedule may be a schedule involving a product designated by the second user from among products to be delivered to the second user, via the second terminal.

A management method according to a second aspect of the present disclosure is executable in a management system for management of schedules of delivery of products directed to users. The management method involves: receiving a first selection of selecting a first schedule of delivery of a first product directed to a first user defined as a first destination, from a first terminal used by the first user; receiving a second selection of selecting a second schedule of delivery of a second product directed to a second user defined as a second destination, from a second terminal used by the second user; and exchanging the first destination involved in the first schedule with the second destination involved in the second schedule, in response to reception of the first selection and the second selection.

A non-transitory information recording medium according to a third aspect of the present disclosure stores a program thereon that causes a computer for management of schedules of delivery of products directed to users to: receive a first selection of selecting a first schedule of delivery of a first product directed to a first user defined as a first destination, from a first terminal used by the first user; receive a second selection of selecting a second schedule of delivery of a second product directed to a second user defined as a second destination, from a second terminal used by the second user; and exchange the first destination involved in the first schedule with the second destination involved in the second schedule, in response to reception of the first selection and the second selection.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

### INDUSTRIAL APPLICABILITY

The present disclosure can provide a management system for management of schedules of delivery of products directed to users, a management method, and a non-transitory information recording medium that can allow users to exchange products before delivery of the products.

What is claimed is:

1. A management system for management of schedules of delivery of products directed to users, the management system comprising:
at least one memory configured to store computer program code; and
at least one processor configured to access the computer program code and operate in accordance of the computer program code, the computer program code including:
first receiving code configured to cause at least one of the at least one processor to receive a first selection of selecting a first schedule of delivery of a first product directed to a first user defined as a first destination, from a first terminal used by the first user;
second receiving code configured to cause at least one of the at least one processor to receive a second selection of selecting a second schedule of delivery of a second product directed to a second user defined as a second destination, from a second terminal used by the second user; and
exchanging code configured to cause at least one of the at least one processor to exchange the first destination involved in the first schedule with the second destination involved in the second schedule, in response to reception of the first selection and the second selection.

2. The management system according to claim 1, further comprising
generating code configured to cause at least one of the at least one processor to generate specific information to be associated with the first selection in response to reception of the first selection, wherein
the management system deems a user using a terminal accessing the management system on basis of the specific information to be the second user using the second terminal and allows for reception of the second selection.

3. The management system according to claim 2, wherein the management system provides the first user with the generated specific information via the first terminal and thereby allows the first user to inform the second user of the generated specific information.

4. The management system according to claim 3, wherein the exchanging code is configured to cause at least one of the at least one processor to requires a necessary condition that the second selection is an earliest selection received before a first exchange deadline involved in the first schedule and before a second exchange deadline involved in the second schedule.

5. The management system according to claim 2, wherein the management system disassociates the specific information from the first selection after completion of exchange.

6. The management system according to claim 5, wherein the management system provides a report to a user using a terminal accessing the management system on basis of the disassociated specific information, the report indicating refusal of exchange with the first product involved in the first schedule.

7. The management system according to claim 1, wherein
the management system asks the first user whether to accept exchange in response to reception of the second selection, and
the exchange requires a necessary condition that the first user provides a response indicating acceptance of the exchange to the management system.

8. The management system according to claim 1, wherein
each of the schedules managed by the management system involves an output timing, the output timing preceding a delivery timing of delivery of the product involved in the schedule or coinciding with the delivery timing, and
the management system further comprises outputting code configured to cause at least one of the at least one processor to output a schedule among the schedules managed by the management system, the schedule reaching the output timing involved in the schedule.

9. The management system according to claim 8, wherein a product involved in the schedule is a product specified in response to a request for lottery from a user.

10. The management system according to claim 1, wherein
the exchanging code configured to cause at least one of the at least one processor to exchange the destinations by:
deleting the first schedule and the second schedule from the schedules to be managed, and
adding a third schedule of delivery of the second product directed to the first user and a fourth schedule of delivery of the first product directed to the second user, to the schedules to be managed.

11. The management system according to claim 1, wherein
the selected first schedule is a schedule involving a product designated by the first user from among products to be delivered to the first user, via the first terminal, and
the selected second schedule is a schedule involving a product designated by the second user from among products to be delivered to the second user, via the second terminal.

12. A management method executable in a management system for management of schedules of delivery of products directed to users, the method comprising:
receiving a first selection of selecting a first schedule of delivery of a first product directed to a first user defined as a first destination, from a first terminal used by the first user;
receiving a second selection of selecting a second schedule of delivery of a second product directed to a second user defined as a second destination, from a second terminal used by the second user; and
exchanging the first destination involved in the first schedule with the second destination involved in the second schedule, in response to reception of the first selection and the second selection.

13. A non-transitory information recording medium storing a program thereon, the program causing a computer for management of schedules of delivery of products directed to users to:
receive a first selection of selecting a first schedule of delivery of a first product directed to a first user defined as a first destination, from a first terminal used by the first user;
receive a second selection of selecting a second schedule of delivery of a second product directed to a second user defined as a second destination, from a second terminal used by the second user; and
exchange the first destination involved in the first schedule with the second destination involved in the second schedule, in response to reception of the first selection and the second selection.
